(19) United States
(12) Patent Application Publication
(10) Pub. No.: US 2022/0383407 A1
(43) Pub. Date: Dec. 1, 2022

(54) NON-TRANSITORY COMPUTER READABLE MEDIUM STORING PROGRAM, INFORMATION PROCESSING APPARATUS, AND INFORMATION PROCESSING METHOD

(71) Applicant: FUJIFILM Business Innovation Corp., Tokyo (JP)

(72) Inventors: Ye Sun, Kanagawa (JP); Ryota Mase, Kanagawa (JP)

(73) Assignee: FUJIFILM Business Innovation Corp., Tokyo (JP)

(21) Appl. No.: 17/544,891

(22) Filed: Dec. 7, 2021

(30) Foreign Application Priority Data
May 26, 2021 (JP) 2021-088751

(51) Int. Cl. G06Q 40/02

(52) U.S. Cl. CPC G06Q 40/025

(57) ABSTRACT

A non-transitory computer readable medium stores a program causing a computer to execute a function of acquiring a security credit rating of a user who operates a terminal used for communication; a function of acquiring a security threat rating for a website that is a communication destination; and a function of controlling the user's communication with the website, based on security policy according to a combination of the credit rating and the threat rating.

### CROSS-REFERENCE TO RELATED APPLICATIONS

This application is based on and claims priority under 35 USC 119 from Japanese Patent Application No. 2021-088751 filed May 26, 2021.

### BACKGROUND

### (i) Technical Field

The present invention relates to a non-transitory computer readable medium storing a program, an information processing apparatus, and an information processing method.

### (ii) Related Art

In today's corporate activities, communication with the outside world via emails and viewing of websites on the Internet are indispensable. On the other hand, there is a risk of malware infection in emails received by employees. Further, the safety rating of a website on the Internet are not the same. Therefore, many companies transmit training emails to employees to raise the security awareness. Further, the threat of a website may be determined by artificial intelligence (AI), and the access of employees to websites with gray security (hereinafter referred to as “gray site”) may be restricted.

Examples of the related art include JP2019-160066A.

### SUMMARY

However, there is a limit to the accuracy of the gray site determination by AI. Therefore, in a case where the security policy generated based on the determination by AI is uniformly applied to the gateway, excessive defense that limits even legitimate communication may occur, which may affect normal business operations.

Aspects of non-limiting embodiments of the present disclosure relate to a non-transitory computer readable medium storing a program, an information processing apparatus, and an information processing method that reduce business problems, as compared with the case where communication is uniformly controlled based on a security policy considering the safety rating of a website.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a non-transitory computer readable medium storing a program causing a computer to execute a function of acquiring a security credit rating of a user who operates a terminal used for communication; a function of acquiring a security threat rating for a website that is a communication destination; and a function of controlling the user's communication with the website, based on security policy according to a combination of the credit rating and the threat rating.

### BRIEF DESCRIPTION OF THE DRAWINGS

Exemplary embodiment(s) of the present invention will be described in detail based on the following figures, wherein:

FIG. 1 is a diagram illustrating a configuration example of a network system assumed in Exemplary Embodiment 1;

FIG. 2 is a diagram illustrating an example of a hardware configuration of a credit rating calculation device;

FIG. 3 is a diagram illustrating an example of a functional configuration of the credit rating calculation device;

FIG. 4 is a diagram illustrating a data example of a user DB;

FIG. 5 is a diagram illustrating a data example of a training email template DB;

FIGS. 6A and 6B are diagrams illustrating an example of designating a training ID, FIG. 6A illustrates an example in which a training level is common to all categories, and FIG. 6B illustrates an example in which the training level is designated for each category of the training email;

FIG. 7 is a diagram illustrating a data example of a training result DB, a part (A) in FIG. 7 is a table in which a user and a training result are linked, and a part (B) in FIG. 7 is detailed data on the training result;

FIGS. 8A to 8C are diagrams illustrating a flow of calculating a credit rating for a user A, FIG. 8A illustrates a period of a training result used for calculating the credit rating, FIG. 8B illustrates a training result of a user A, and FIG. 8C illustrates an example of the calculated credit rating;

FIG. 9 is a diagram illustrating an example of a hardware configuration of a blocking policy device;

FIG. 10 is a diagram illustrating an example of a functional configuration of a blocking policy device;

FIGS. 11A and 11B are diagrams illustrating a relationship between a threat rating learning device and a learned model, FIG. 11A is a configuration example of the threat rating learning device, and FIG. 11B is a configuration example of a domain threat rating determination unit incorporating the learned model;

FIG. 12 is a diagram illustrating an example of a threat rating;

FIGS. 13A to 13C are diagrams illustrating a data example of a threshold table by credit rating, FIG. 13A illustrates a relationship between the credit rating and a security policy according to the threat rating, FIG. 13B illustrates an example in which communication is permitted, and FIG. 13C illustrates an example in which communication is blocked;

FIG. 14 is a flowchart illustrating an example of a training process by a security training unit;

FIG. 15 is a flowchart illustrating an example of a credit rating calculation or update process by a security training unit;

FIG. 16 is a flowchart illustrating an example of controlling communication by a blocking policy device;

FIG. 17 is a flowchart illustrating a method of updating credit rating used in Exemplary Embodiment 2;

FIG. 18 is a diagram illustrating an example of managing credit rating used for controlling communication on a job title basis;

FIG. 19 is a diagram illustrating an example of managing credit rating used for controlling communication on a LAN basis to which terminals operated by users are connected;

FIG. 20 is a diagram illustrating an example of managing credit ratings of users for each category;

FIG. 21 is a diagram illustrating an example of managing the credit rating in units of groups to which users belongs;

FIGS. 22A and 22B are diagrams illustrating an example of a threshold table by credit rating prepared for each website category, FIG. 22A illustrates a threshold table by credit rating for a shopping site, and FIG. 22B illustrates a threshold table by credit rating for a game site;

FIGS. 23A and 23B are diagrams illustrating an example of preparing different threshold tables by credit rating according to a difference in a method of delivering input data, FIG. 23A illustrates a threshold table by credit rating for POST, and FIG. 23B illustrates a threshold table by credit rating for GET; and

FIGS. 24A and 24B are diagrams illustrating an example of preparing different threshold tables by credit rating according to a difference in action to a website that is a communication destination, FIG. 24A illustrates a threshold table by credit rating for login, and FIG. 24B illustrates a threshold table by credit rating for posting.

### DETAILED DESCRIPTION

Hereinafter, exemplary embodiments of the present invention will be described with reference to the drawings.

### Exemplary Embodiment 1

### System Example

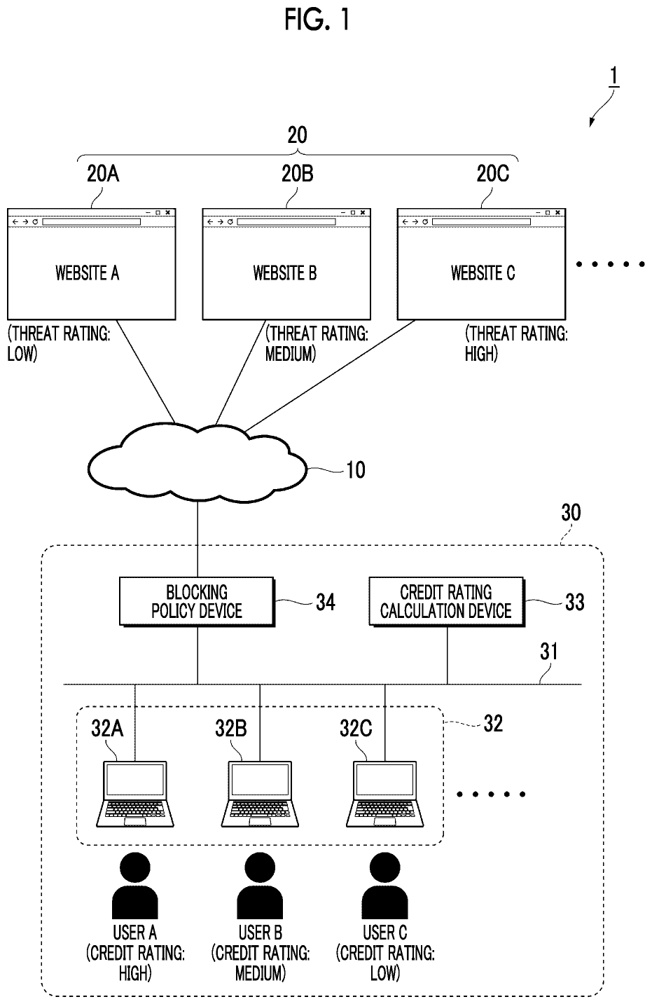

FIG. 1 is a diagram illustrating a configuration example of a network system 1 assumed in Exemplary Embodiment 1.

The network system 1 illustrated in FIG. 1 includes an Internet 10, web servers 20A, 20B and 20C, and a Local Area Network (LAN) system 30 on the business operator side.

However, a 4G or 5G mobile communication system may be used for the communication executed between the web servers 20A, 20B and 20C and the LAN system 30.

In the following, in a case where a plurality of web servers 20A, 20B and 20C are not distinguished, the web servers are referred to as web servers 20.

In FIG. 1, for convenience of explanation, only one LAN system 30 is illustrated, but a plurality of LAN systems 30 are connected to the actual network system 1.

In the case of the present exemplary embodiment, the plurality of web servers 20A, 20B and 20C are operated by different business operators. For example, the web server 20A is operated by the business operator A, the web server 20B is operated by the business operator B, and the web server 20C is operated by the business operator C.

However, a single business operator may operate a plurality of web servers 20. The business operators here are not limited to corporations, but also include individuals who are natural persons.

However, the operator of the web server 20 is not limited to the business operator, and may be operated by a malicious individual.

In FIG. 1, the website provided by the web server 20A is referred to as “website A”, the website provided by the web server 20B is referred to as “website B”, and the website provided by the web server 20C is referred to as “website C”.

A website here is a collection of one or more pages. Therefore, the user who has accessed the web server 20 can browse one or more pages.

Incidentally, the rating of security threat associated with viewing a website (hereinafter referred to as “threat rating”) is not the same.

In the example of FIG. 1, for convenience of explanation, it is assumed that the threat rating of website A is low, the threat rating of website B is medium, and the threat rating of website C is high.

The “threat rating” in the present exemplary embodiment has the opposite relationship with the security level of security related to access to a web page (hereinafter, also referred to as “safety rating”).

For example, website A with a low threat rating has the highest safety rating among the three websites illustrated in FIG. 1, and website C with a high threat rating has the lowest safety rating among the three websites illustrated in FIG. 1.

Examples of the website with a high threat rating include websites that may be infected with link spam or malware, fraudulent sites, and suspicious sites.

The LAN system 30 includes a LAN 31, a terminal 32 operated by the user, a credit rating calculation device 33 that calculates the rating of credit (hereinafter referred to as “credit rating”) regarding the security of the user, and a blocking policy device 34 that controls communication based on the credit rating of the user who is the executor of the communication and the threat rating of the website that is the communication destination.

In FIG. 1, a terminal 32A operated by the user A, a terminal 32B operated by the user B, and a terminal 32C operated by the user C are arranged.

For convenience of explanation, the credit rating of user A is high, the credit rating of user B is medium, and the credit rating of user C is low.

The height of the credit rating here refers to the height of awareness of security (hereinafter referred to as “security awareness”) collected for each user.

The credit rating for each user is calculated based on, for example, the history of the result of the dealing with or responding to harmless emails (hereinafter referred to as “training emails”) that imitate attack-type emails. Training using training emails is an example of training for acquiring the ability to respond to attack-type emails (hereinafter referred to as “security training”).

In the case of the present exemplary embodiment, as training emails, both or one of an email with files containing harmless target malware attached and an email including a link to a uniform resource locator (URL) of a harmless training website is used. In the present exemplary embodiment, the former is called an attached file type training email, and the latter is called a URL type training email.

In the case of the attached file type training email, the user's dealing or response includes “has not opened”, “has opened”, and “has opened but reported to the administrator”. On the other hand, in the case of the link type, the user's dealing or response includes “has not accessed”, “has accessed”, and “has accessed but reported to the administrator”.

The file attached to the attached file type training email contains a key associated with the user to be trained. Further, the file is provided with a function of reporting the opening of the file to the credit rating calculation device 33. Therefore, the credit rating calculation device 33 that has received the opening report can specify the user who has opened the file.

On the other hand, in the case of the URL type training email, the URL to be linked includes, for example, an access key associated with the user to be trained.

The URL of the link destination is described in the format of, for example, “http://xxxxxxxx/access-key-id”. In this example, the “access-key-id” part is the access key.

However, in a case where proxy authentication is used, it is possible to perform an operation without including the access key in the URL of the link destination. In this case, the information on the user who has accessed the training website is collected through the access log of the proxy server.

The credit rating calculation device 33 calculates the credit rating in a predetermined administrative unit, based on the history of the result of the dealing with or responding to training email. The smallest administrative unit is the individual. However, as the administrative unit, it is also possible to use a group, a job title, and a specific LAN to which a terminal 32 operated by a user is connected.

Examples of group include boards of directors, departments, sections, rooms, and teams. In a case where “group” is used as the unit of credit rating, a value calculated by using the credit rating calculated individually for the members configuring the group is used. For this value, for example, the average value, the minimum value, and the maximum value of the credit rating calculated for each member may be used. However, the administrator may set the administrative value individually for each group.

Examples of the job title include directors, officers, executive officers, managers, department managers, group leaders, subgroup leaders, employees, part-time workers, dispatched laborers, and internships.

In a case where “job title” is used as the unit of credit rating, a value calculated by using the credit rating calculated individually for the members configuring the job title is used. For this value, for example, the average value, the minimum value, and the maximum value of the credit rating calculated for each member may be used. However, the administrator may set the administrative value individually for each job title.

Examples of a specific LAN to which the terminal 32 operated by the user is connected include a network laid on a specific floor and a specific room, and a network managed by a router.

In a case where “LAN” is used as the unit of credit rating, the average value, the minimum value, and the maximum value of the credit rating calculated for each user who uses the terminal 32 connected to the network to be managed may be used. However, the administrator may set the administrative value individually for each LAN.

Further, the credit rating of the user may be calculated from the history of past communication regarding the user, or may be calculated according to the result of a past test (hereinafter referred to as “security test”) that asks the level of security awareness of the user.

In a case where there are a plurality of calculated credit ratings, the total credit rating may be recalculated by using the plurality of credit ratings. At this time, the closer the calculation time is to the current time, the larger the weight may be, and the overall credit rating may be recalculated.

The weight may be assigned non-linearly rather than linearly with respect to the elapsed time from the time when the event used for calculating the credit rating has occurred to the current time. Specifically, the longer the elapsed time, the smaller the weight may be non-linearly.

The credit rating of the user may be given by a combination of a plurality of pieces of illustrated information. At that time, a plurality of pieces of information may be weighted. For example, the weight of the credit rating calculated based on the result of dealing with or responding to the training email and the credit rating calculated based on the result of the security test may be heavier than the credit rating calculated based on the communication history.

In the present exemplary embodiment, a user that is the minimum unit is used as the unit of credit rating.

The blocking policy device 34 controls the availability of communication with a specific website by the user, based on a policy on security (hereinafter referred to as “security policy”) according to a combination of the security credit rating of the user who operates the terminal 32 and the threat rating of the website that is the communication destination. That is, the availability of communication is determined based not only on the credit rating of the user or the threat rating of the website that is the communication destination, but also on the combination of the credit rating of the user and the threat rating of the website that is the communication destination. Therefore, even users with low credit rating are permitted to view highly secure websites.

However, the range of websites that are permitted to be viewed by users with low credit rating is narrower than the range of websites that are permitted to be viewed by users with high credit rating.

Communication with websites that are not permitted to be viewed will be blocked.

Here, the threat rating of the website may be generated by the blocking policy device 34 or may be acquired from an external device. In the present exemplary embodiment, it is said that the “threat rating” is acquired in each case.

Hardware Configuration

Configuration of Credit Rating Calculation Device

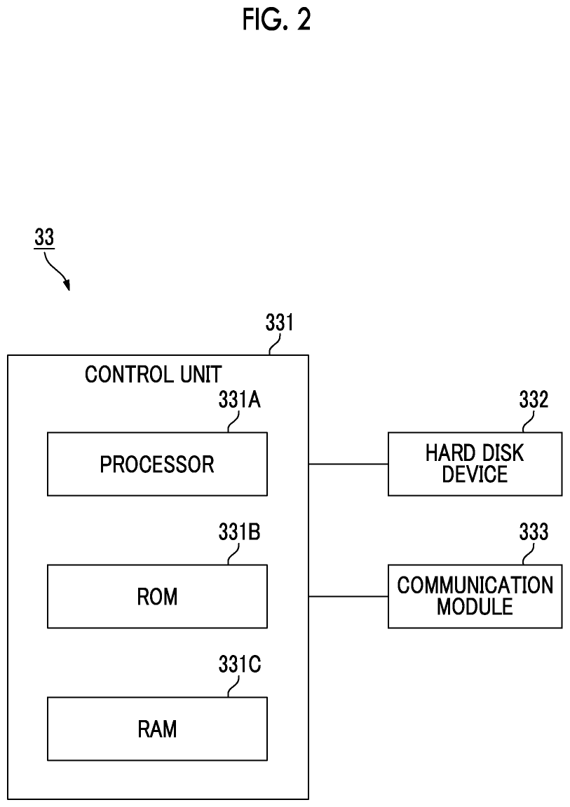

FIG. 2 is a diagram illustrating an example of a hardware configuration of the credit rating calculation device 33.

The credit rating calculation device 33 illustrated in FIG. 2 includes a control unit 331, a hard disk device 332, and a communication module 333. The control unit 331 here is a so-called computer. Further, a display, a keyboard, and a mouse may be connected to the credit rating calculation device 33.

The control unit 331 has a processor 331A, a ROM 331B, and a RAM 331C.

The processor 331A is composed of, for example, a CPU. The processor 331A implements various functions through the execution of the program.

The BIOS and the like are stored in the ROM 331B. Further, the RAM 331C that is the main storage device is used as a work area of the program.

The hard disk device 332 is an auxiliary storage device and stores an operating system and an application program. Hereinafter, the operating system and the like are also simply referred to as “programs”.

In the case of the present exemplary embodiment, the hard disk device 332 stores a program for calculating the credit rating.

In the present exemplary embodiment, the hard disk device 332 is used, but a semiconductor memory may be used instead of the hard disk device 332.

The communication module 333 is a device used for communication with the outside, and may be a device for wired communication or a device for wireless communication.

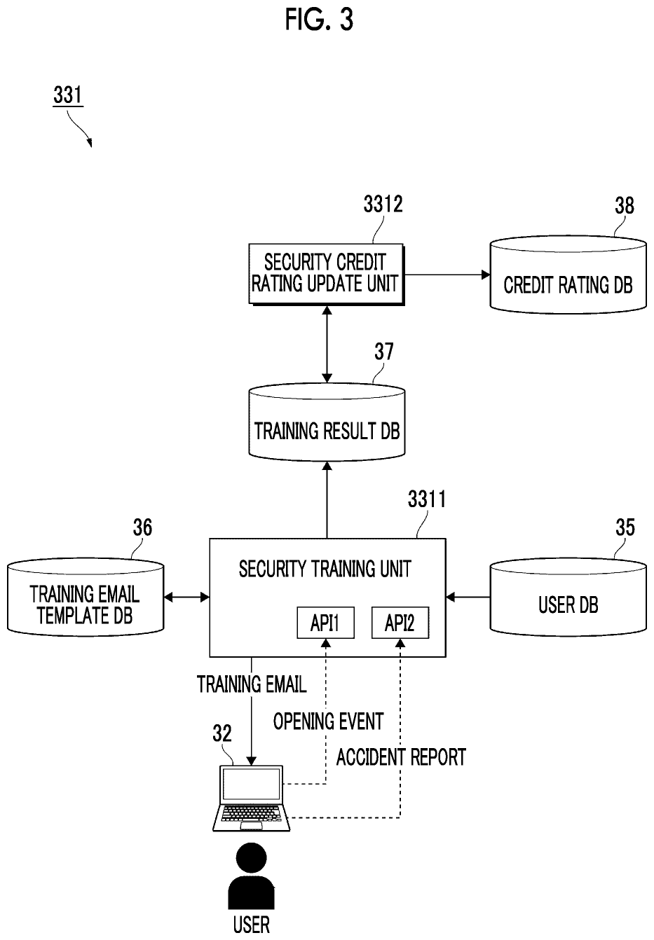

FIG. 3 is a diagram illustrating an example of the functional configuration of the credit rating calculation device 33 (see FIG. 1).

The functional configuration illustrated in FIG. 3 is achieved by the control unit 331 executing a program.

The control unit 331 in the present exemplary embodiment functions as a security training unit 3311 that executes training using training email, and a security credit rating update unit 3312 that updates the credit rating of the user for security awareness by using the training results.

In a case of transmitting the training email, the security training unit 3311 acquires the user's email address from the user database (DB) 35, and acquires the template of the training email from the training email template DB 36.

There are two types of training emails, that is, an attached file type and a URL type, and an email of one of the types is transmitted to the user to be trained. The type of training email to be transmitted may be scheduled in advance or may be randomly determined for each transmission.

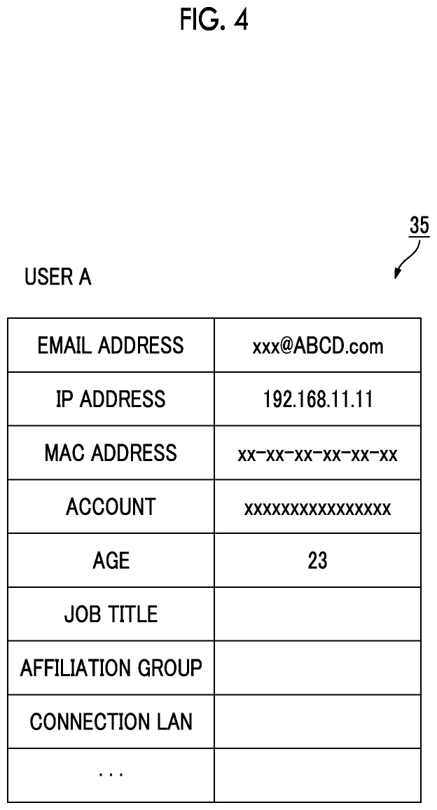

FIG. 4 is a diagram illustrating a data example of the user DB 35. The user DB 35 stores information on all users who operate the terminal 32 (see FIG. 1) connected to the LAN system 30 (see FIG. 1).

FIG. 4 illustrates an example of data on the user A among the information pieces stored in the user DB 35. In the case of FIG. 4, for user A, the email address, IP address, MAC address, account, age, job title, affiliation group, and a LAN to which the operated terminal 32 is connected (hereinafter referred to as “connection LAN”) are stored.

However, in the case of the present exemplary embodiment, the email address used for reading the credit rating may be stored.

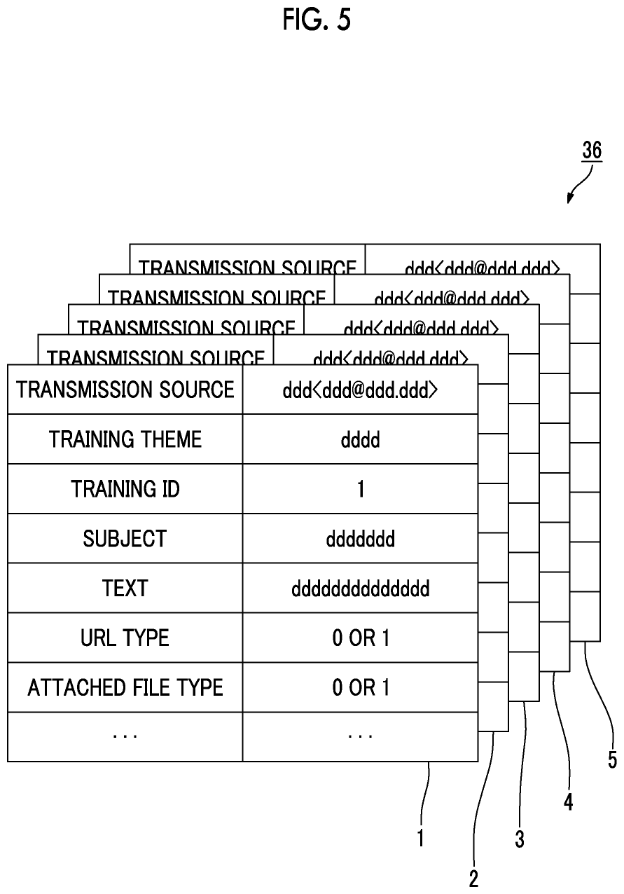

FIG. 5 is a diagram illustrating a data example of a training email template DB 36. A plurality of templates are stored in the training email template DB 36. In the case of FIG. 5, the plurality of templates correspond to training levels 1 to 5. Different training levels correspond to different levels of required security awareness.

For example, training level 1 has the lowest required security awareness, while training level 5 has the highest required security awareness. Users with higher security awareness are less likely to be infected with malware by opening or accessing linked sites, and users with lower security awareness are more likely to be infected with malware by opening or accessing linked sites.

The number of training templates is not limited to one for one training level, and a plurality of training templates may be prepared. For example, a plurality of templates may be prepared for training level 1.

Further, the training level is not limited to 5 steps. For example, the training level may be 3 steps or 10 steps.

Further, for example, it is desirable that the text of the training email transmitted is customized according to the category designated separately. In the case of the present exemplary embodiment, shopping, media sharing, games, SNS, technology, and business are assumed as categories.

The category here is an example of the classification to which the website of the communication destination belongs.

The training template illustrated in FIG. 5 is composed of items such as a transmission source, a training theme, a training ID, a subject, a text, a URL type, and an attached file type.

The email address of the transmission source is displayed as the transmission source of the training email. A value of “0” or “1” is used for the URL type and the attached file type, respectively. “0” refers to not using the corresponding function, and “1” refers to using the corresponding function. At least one is “1”. Both the URL type and the attached file type may be “1”.

Referring back to the description of FIG. 3.

The security training unit 3311 transmits a training email generated according to the template to the user to be trained. Specifically, a training email is transmitted to the email address of the user to be trained.

In a case of transmitting the training email, the security training unit 3311 generates the training email by using the training template corresponding to the training ID designated by the administrator or the training ID randomly designated.

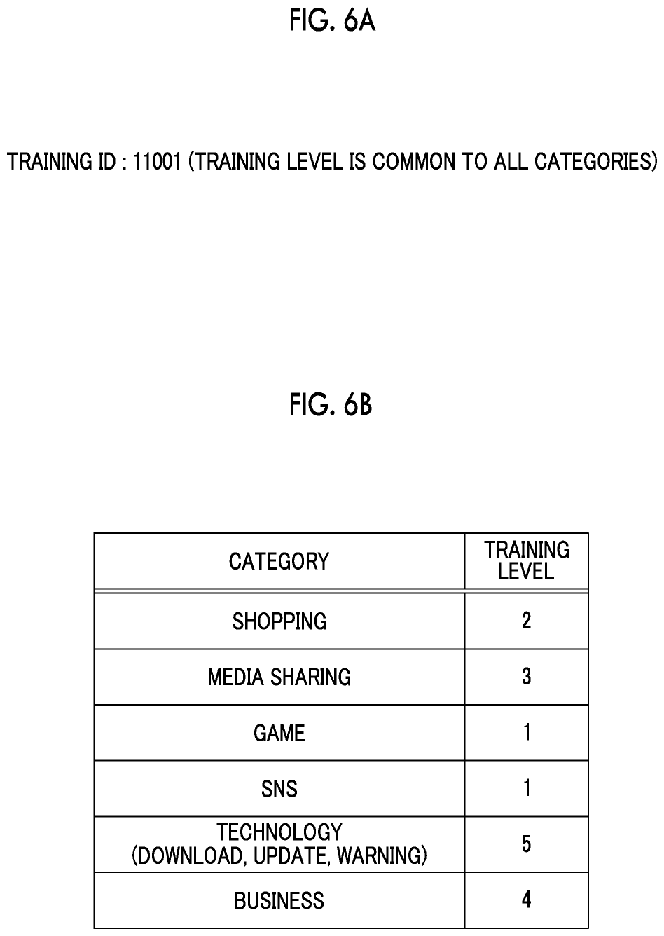

FIGS. 6A and 6B are diagrams illustrating an example of designating a training ID. FIG. 6A illustrates an example in which a training level is common to all categories, and FIG. 6B illustrates an example in which the training level is designated for each category of the training email.

In the case of FIG. 6B, the game and social networking service (SNS) have training level 1, shopping has training level 2, media sharing has training level 3, business has training level 4, and technology has training level 5.

In the example illustrated in FIGS. 6A and 6B, the training level is designated according to the category of the training email to be transmitted, but the training level may be designated for each combination of the user and the category. This is because the same user may not have the same security awareness in all categories. By reflecting the difference in user's security awareness for each category in the training email, it is possible to enhance the effectiveness of the training.

The security training unit 3311 is provided with two application programming interfaces (APIs). One is API1 for receiving notification of the opening of a file attached to the training email and the access to the URL described in the training email, and the other is API2 for receiving a report of a security accident.

In a case where the security training unit 3311 receives a report of opening or an accident, the security training unit 3311 registers the occurrence of each event in the training result DB 37.

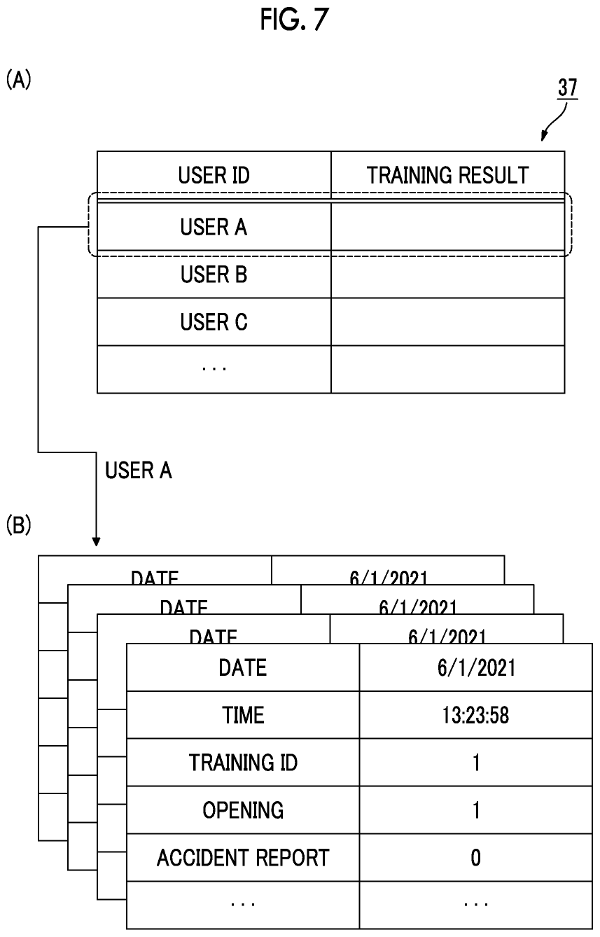

FIG. 7 is a diagram illustrating a data example of the training result DB 37. A part (A) in FIG. 7 is a table in which a user and a training result are linked, and a part (B) in FIG. 7 is detailed data on the training result.

The training result DB 37 records the date and time when the training email has been transmitted, the training ID, the presence/absence of opening, and the presence/absence of an accident report in association with the user. In the case of FIG. 7, “1” in the open field refers that the email has been opened, and “0” in the accident report field refers that the user has not reported a security accident.

Referring back to the description of FIG. 3.

The security credit rating update unit 3312 refers to the training result DB 37, periodically calculates the credit rating for each user, and registers the calculated credit rating in the credit rating DB 38. In the case of the present exemplary embodiment, the calculated credit rating is used to determine whether or not to permit the user to communicate with an external website.

The period used to calculate the credit rating is given, for example, as an initial value. For example, the period is given on a monthly, three-month, or six-month basis. However, the system administrator can freely designate the period.

The security credit rating update unit 3312 counts the number of training emails sent to users, the number of opened emails, and the number of accident reports within a designated period, and calculates the credit rating for each user.

Specifically, the security credit rating update unit 3312 calculates a low numerical value as the credit rating of the user who has opened the attached file or the user who has not reported the security accident. A predetermined formula or the like is used to calculate the credit rating.

In calculating the credit rating, the training level for each training email, the old and new between training results, the closeness between the training email transmission time and the current time, and the omission of accident reports may be taken into consideration. Further, the credit rating may be calculated by weighting these pieces of information.

For example, as there are many cases recently where the opening of the training email is not reported, or as the importance of the training level that has resulted in a security accident is higher, formulas and rules that reduce the numerical values or levels of credit rating are applied.

The credit rating may be calculated by adding information such as the age of the user. In that case, for example, the younger the age, the heavier the weight, and the older the age, the lighter the weight. Conversely, the younger the age, the lighter the weight, and the older the age, the heavier the weight.

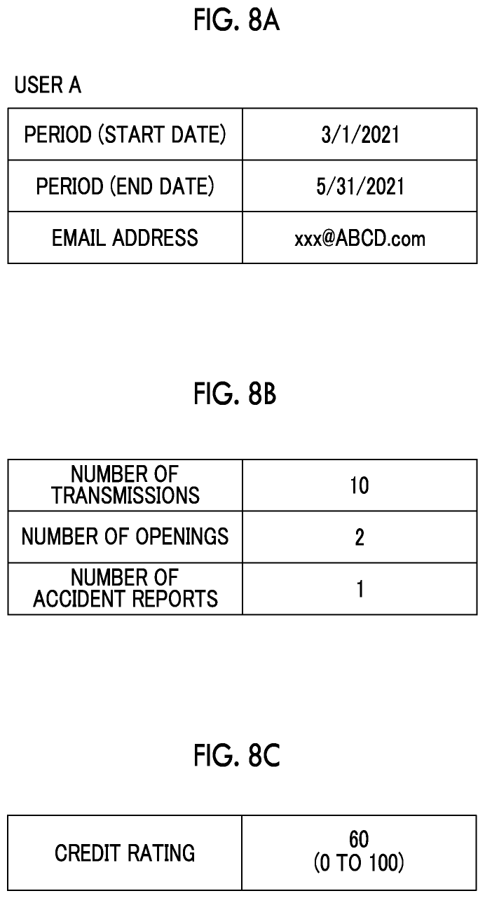

FIGS. 8A to 8C are diagrams illustrating a flow of calculating a credit rating for a user A. FIG. 8A illustrates a period of a training result used for calculating the credit rating, FIG. 8B illustrates a training result of a user A, and FIG. 8C illustrates an example of the calculated credit rating;

In the case of FIGS. 8A to 8C, the period used for calculating the credit rating is three months from March to May 2021, and the email address of the user A is “xxx@ABCD.com”. The number of transmissions associated with this email address is 10, of which two emails have been opened and accident has been reported for one email. That is, the report from the user A is not recorded at the first time among the two times of opening. Therefore, the credit rating is calculated as “60”. The credit rating in the present exemplary embodiment is given as a numerical value among 0 to 100.

Configuration of Blocking Policy Device

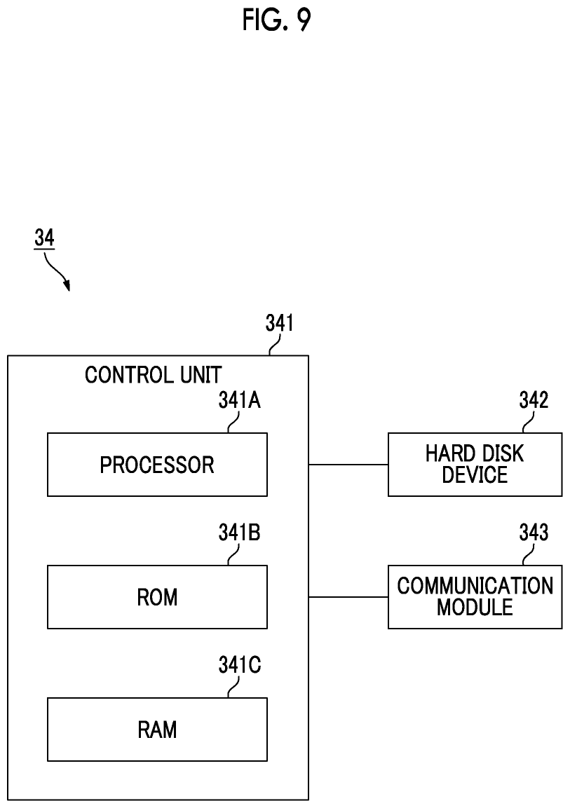

FIG. 9 is a diagram illustrating an example of a hardware configuration of the blocking policy device 34.

The blocking policy device 34 illustrated in FIG. 9 includes a control unit 341, a hard disk device 342, and a communication module 343. The control unit 341 is a so-called computer. Further, a display, a keyboard, and a mouse may be connected to the blocking policy device 34.

The blocking policy device 34 is an example of an information processing apparatus.

The control unit 341 has a processor 341A, a ROM 341B, and a RAM 341C.

The processor 341A is composed of, for example, a CPU. The processor 341A implements various functions through the execution of the program.

The BIOS and the like are stored in the ROM 341B. Further, the RAM 341C, which is the main storage device, is used as a work area of the program.

The hard disk device 342 is an auxiliary storage device and stores an operating system and an application program.

In the case of the present exemplary embodiment, the hard disk device 342 stores an application program that controls the availability of communication with an external website for each user.

In the present exemplary embodiment, the hard disk device 342 is used, but a semiconductor memory may be used instead of the hard disk device 342.

The communication module 343 is a device used for communication with the outside, and may be a device for wired communication or a device for wireless communication.

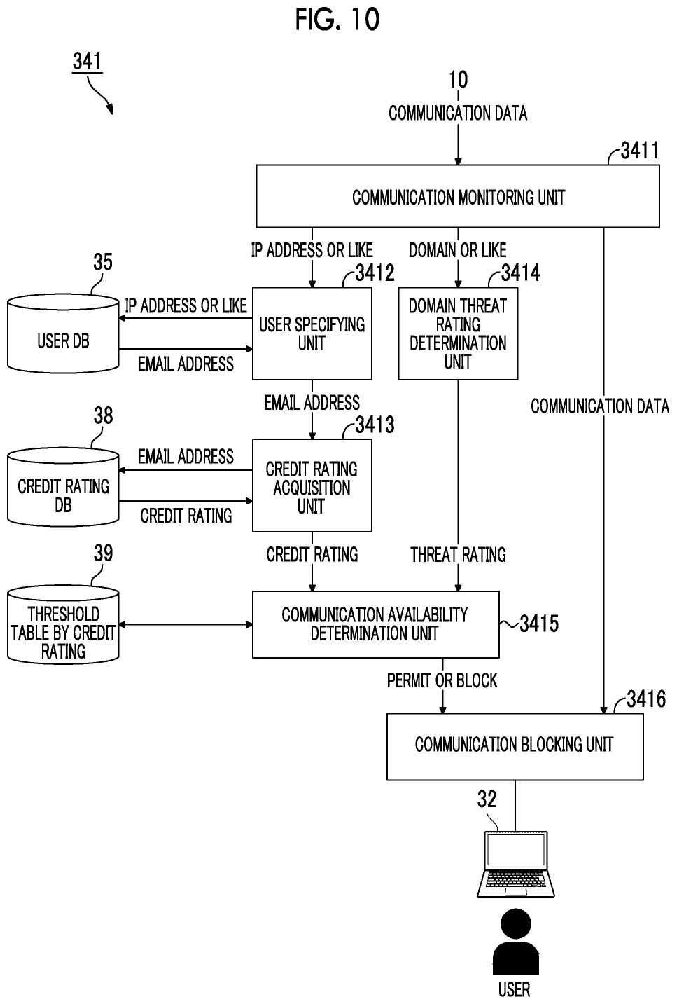

FIG. 10 is a diagram illustrating an example of the functional configuration of the blocking policy device 34 (see FIG. 1).

The functional configuration illustrated in FIG. 10 is achieved by the control unit 341 executing a program.

The control unit 341 in the present exemplary embodiment functions as a communication monitoring unit 3411 that monitors communication with the Internet 10, a user specifying unit 3412 that specifies a user who is the executor of communication, a credit rating acquisition unit 3413 that acquires the credit rating of the specified user, a domain threat rating determination unit 3414 that determines the threat rating of the domain of a website that is the communication destination, a communication availability determination unit 3415 that determines the availability of communication according to the combination of the credit rating of the user and the domain threat rating, and a communication blocking unit 3416 that performs control of passing or blocking communication data.

The communication monitoring unit 3411 monitors the communication data with the Internet 10 and gives an Internet Protocol (IP) address or the like to the user specifying unit 3412. Further, the communication monitoring unit 3411 acquires, from the communication data, the domain, a fully qualified domain name (FQDN), URL, or the like (hereinafter referred to as “domain”) of the website that is the communication destination, and gives the acquired domain to the domain threat rating determination unit 3414.

Further, the communication monitoring unit 3411 gives the communication data received from the website that is the communication destination, to the communication blocking unit 3416.

The user specifying unit 3412 refers to the user DB by using the IP address or the like given by the communication monitoring unit 3411, and acquires the corresponding email address. The email address here is used to read the credit rating associated with the user. Therefore, in a case where the credit rating can be read, the information read from the user DB 35 is not limited to the email address. For example, instead of the email address, the account and MAC address may be read from the user DB 35. In a case where the user can be specified based on the IP address, the user specifying unit 3412 is unnecessary.

The credit rating acquisition unit 3413 uses the email address given by the user specifying unit 3412 to acquire the credit rating of the user who is executing the communication from the credit rating DB 38. The credit rating acquisition unit 3413 gives the acquired credit rating to the communication availability determination unit 3415. The credit rating here is calculated by the credit rating calculation device 33 (see FIG. 1) described above, and is registered in the credit rating DB 38.

The domain threat rating determination unit 3414 gives the threat rating of the website to the communication availability determination unit 3415, based on the domain or the like given by the communication monitoring unit 3411.

The domain threat rating determination unit 3414 used in the present exemplary embodiment gives information of “domain or the like” as an input to the learned model obtained by learning the relationship between the domain or the like and the threat rating, and outputs the “threat rating” as an output.

The learned model generation may be executed as a part of the function of the blocking policy device 34 (see FIG. 1), may be executed as a function of a dedicated device connected to the LAN 31 (see FIG. 1), or may be executed as a function of a dedicated device connected to the Internet 10 (see FIG. 1).

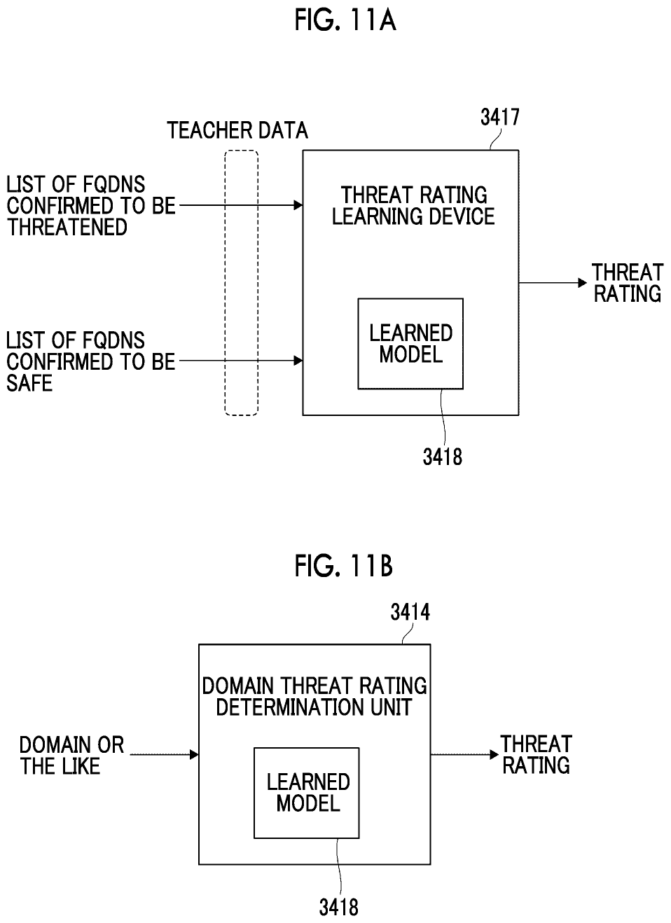

FIGS. 11A and 11B are diagrams illustrating a relationship between the threat rating learning device 3417 and the learned model 3418. FIG. 11A is a configuration example of the threat rating learning device 3417, and FIG. 11B is a configuration example of the domain threat rating determination unit 3414 incorporating the learned model 3418.

The threat rating learning device 3417 illustrated in FIG. 11A is so-called artificial intelligence, and learns the relationship between the domain or the like and the threat rating by deep learning, machine learning, or the like. The model generated by learning is the learned model 3418.

In the present exemplary embodiment, as teacher data, a list of FQDNs confirmed to be threatened and a list of FQDNs confirmed to be safe are given. The threat rating learning device 3417 expands the input FQDNs into IP addresses, country information, and net names for learning, and calculates numerical values for giving the threat rating of the connection destination. In the case of the present exemplary embodiment, the threat rating is calculated as a numerical value of 0 or more and 1 or less.

The domain threat rating determination unit 3414 in the present exemplary embodiment uses this learned model 3418 to output the threat rating corresponding to the input domain or the like.

However, the domain threat rating determination unit 3414 may give a domain to an external device having the learned model 3418 and acquire the corresponding threat rating.

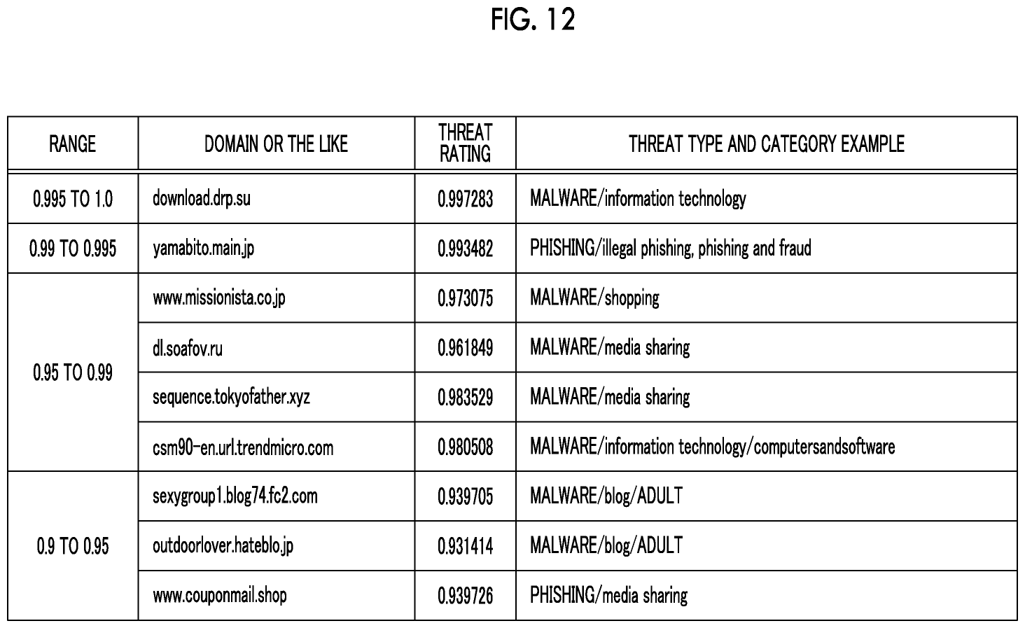

FIG. 12 is a diagram illustrating an example of a threat rating. The table illustrated in FIG. 12 shows examples of threat rating range, domain or the like, threat rating, and threat type and category example or the like.

In the case of FIG. 12, the domain whose threat rating is included in “0.995 to 1.0” is only “download.drp.su”. The type of threat is malware and the category is information technology.

Further, the only domain whose threat rating is included in “0.99 to 0.995” is “yamabito.main.jp”. The type of threat is phishing and the category is illegal phishing.

Further, there are four domains whose threat ratings are included in “0.95 to 0.99”. In the case of FIG. 12, the types of threats are malware. The categories are shopping, media sharing, and information technology.

Further, there are three domains whose threat ratings are included in “0.9 to 0.95”. In the case of FIG. 12, the types of threats are malware and phishing, and the categories are adult and media sharing.

Referring back to the description of FIG. 10.

In a case where the communication availability determination unit 3415 receives the credit rating and the threat rating for the communication to be controlled, the communication availability determination unit 3415 determines the availability of communication with reference to the threshold table 39 by credit rating.

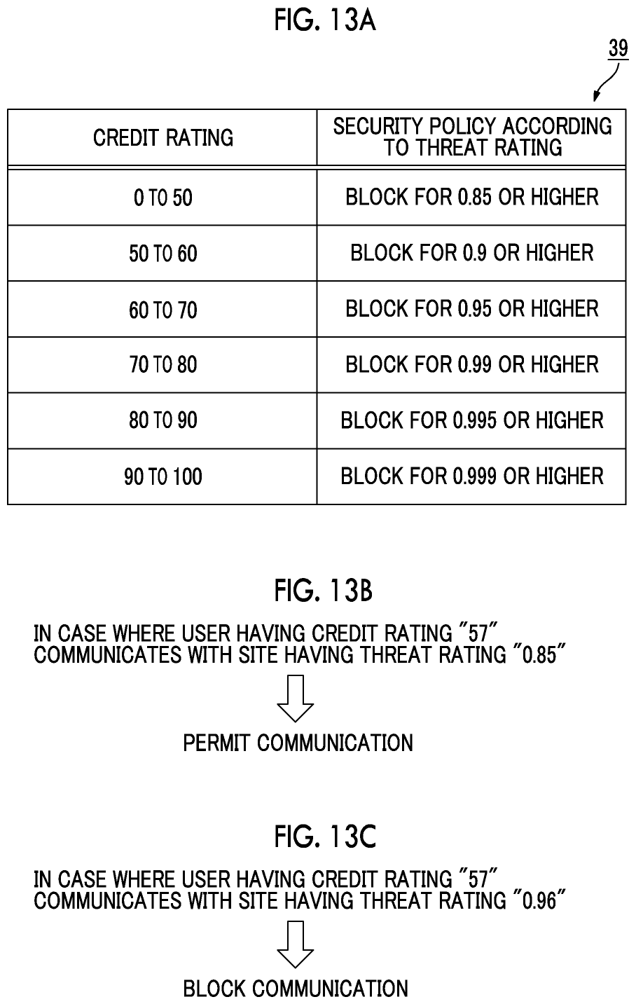

FIGS. 13A to 13C are diagrams illustrating a data example of a threshold table 39 by credit rating. FIG. 13A illustrates a relationship between the credit rating and a security policy according to the threat rating, FIG. 13B illustrates an example in which communication is permitted, and FIG. 13C illustrates an example in which communication is blocked.

The threshold table 39 by credit rating here is an example of a security policy.

In the example of FIGS. 13A and 13B, users having a credit rating of “0 to 50” are permitted to communicate with domains having a threat rating of less than 0.85, but are blocked from communicating with domains having a threat rating of 0.85 or higher.

Further, users having a credit rating of “50 to 60” are permitted to communicate with domains with a threat rating of less than 0.9, but are blocked from communicating with domains having a threat rating of 0.9 or higher.

Further, users having a credit rating of “60 to 70” are permitted to communicate with domains with a threat rating of less than 0.95, but are blocked from communicating with domains having a threat rating of 0.95 or higher.

Further, users having a credit rating of “70 to 80” are permitted to communicate with domains with a threat rating of less than 0.99, but are blocked from communicating with domains having a threat rating of 0.99 or higher.

Further, users having a credit rating of “80 to 90” are permitted to communicate with domains with a threat rating of less than 0.995, but are blocked from communicating with domains having a threat rating of 0.995 or higher.

Further, users having a credit rating of “90 to 100” are permitted to communicate with domains with a threat rating of less than 0.999, but are blocked from communicating with domains having a threat rating of 0.999 or higher.

Therefore, the user having the credit rating “57” is permitted to communicate with the domain having the threat rating “0.85”, and the user having the credit rating “57” is blocked from communicating with the domain having the threat rating “0.96”.

That is, the communication availability determination unit 3415 permits the user with a high credit rating to access the gray site, while blocking the user with a low credit rating from accessing the gray site.

Referring back to the description of FIG. 10.

The communication blocking unit 3416 permits or blocks the transmission of communication data to the terminal 32 operated by the user, based on the permission or blocking information notified from the communication availability determination unit 3415.

As a result, users are permitted to view and communicate with websites with threat ratings that are permitted in relation to the credit ratings of the users, but are blocked from viewing and communicating with websites with threat ratings that are not allowed in relation to the credit rating.

The communication control is executed not only for the communication data from the website to the terminal 32 but also for the communication data from the terminal 32 to the website.

Processing Operation

Hereinafter, the processing operation by the credit rating calculation device 33 (see FIG. 1) and the blocking policy device 34 (see FIG. 1) configuring the LAN system 30 (see FIG. 1) will be described.

Execution of Training and Calculation of Credit Rating

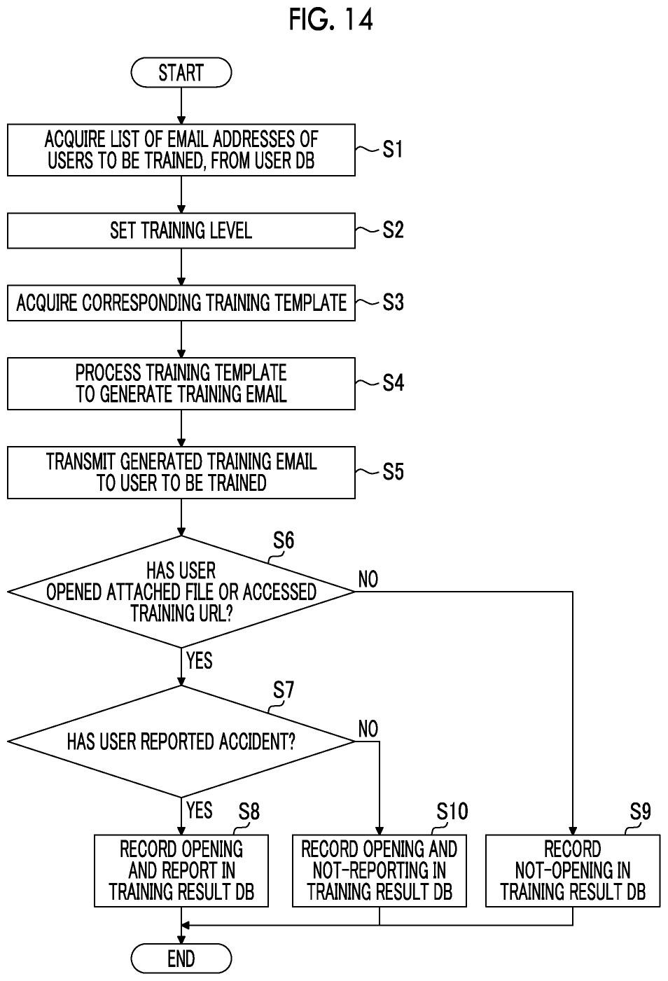

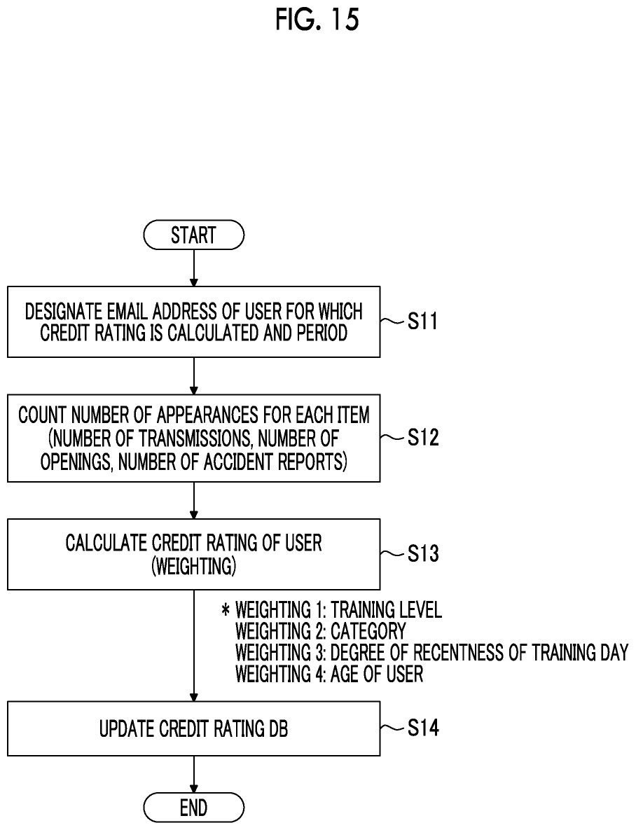

The calculation and update of the credit rating by the credit rating calculation device 33 will be described with reference to FIGS. 14 and 15.

FIG. 14 is a flowchart illustrating an example of a training process by the security training unit 3311 (see FIG. 3). The processing operation illustrated in FIG. 14 is achieved by executing a program by the control unit 331 (see FIG. 2) of the security training unit 3311. The symbol S illustrated in the drawings refer to a step.

In a case where the pre-scheduled training timing arrives, the control unit 331 acquires a list of email addresses of the users to be trained, from the user DB 35 (see FIG. 10) (step S1). The users to be trained may be different for each training. In a case where the user who transmits the training email is different for each training, a list of users to whom the training email is sent is prepared. Further, the person in charge of training may designate a specific email address.

Next, the control unit 331 sets the training level (step S2). The training level may be designated by the person in charge of training or the administrator, or may be randomly designated by the program. The training level may be common to all users to be trained or may be different for each user.

In a case where the training level is set, the control unit 331 acquires the corresponding training template (step S3).

Next, the control unit 331 processes the training template to generate a training email (step S4), and transmits the generated training email to the user to be trained (step S5).

After that, the control unit 331 determines whether or not the user has opened the attached file or accessed the training URL (step S6). This determination is executed for all users to be trained.

In a case where a positive result is obtained in step S6, the control unit 331 determines whether or not the user has reported an accident (step S7).

In a case where a positive result is also obtained in step S7, the control unit 331 records the opening and the report in the training result DB 37 (step S8). This recording is executed for all corresponding users. Further, the training result DB 37 also records information capable of specifying the date and time of transmission of the training email and the training level.

Incidentally, in a case where a negative result is obtained in step S6, the control unit 331 records not-opening in the training result DB 37 (step S9).

In a case where a negative result is obtained in step S7, the control unit 331 records the opening and not-reporting in the training result DB 37 (step S10).

FIG. 15 is a flowchart illustrating an example of a credit rating calculation or update process by the security training unit 3311 (see FIG. 3). The processing operation illustrated in FIG. 15 is achieved by executing a program by the control unit 331 (see FIG. 2) of the security training unit 3311.

In a case where the timing for calculating the credit rating arrives, the control unit 331 designates the email address of the user for which the credit rating is calculated and period (step S11). The range of users for which credit ratings are calculated may be different each time. In a case where the range of users for which credit ratings are calculated is different for each calculation, a list of users is prepared for each calculation. Further, the person in charge of training may designate a user for which the credit rating is calculated.

Next, the control unit 331 counts the number of appearances for each item (step S12). The count here is executed for each user. The items to be counted are the number of transmissions, the number of openings, and the number of accident reports of training emails sent within the corresponding period.

In a case where the count of the number of appearances is completed, the control unit 331 calculates the credit rating of the user (step S13).

The credit rating may be calculated by weighting. For example, weights may be added according to the difference in training level. Further, weights may be added according to the difference in categories. Further, weights may be added according to the degree of recentness of the training day. Further, weights may be added according to the age of the user.

In a case where the credit rating is calculated, the control unit 331 updates the credit rating DB 38 (see FIG. 3) (step S14).

Through the above processing operation, the credit rating of the user is periodically updated.

Communication Control

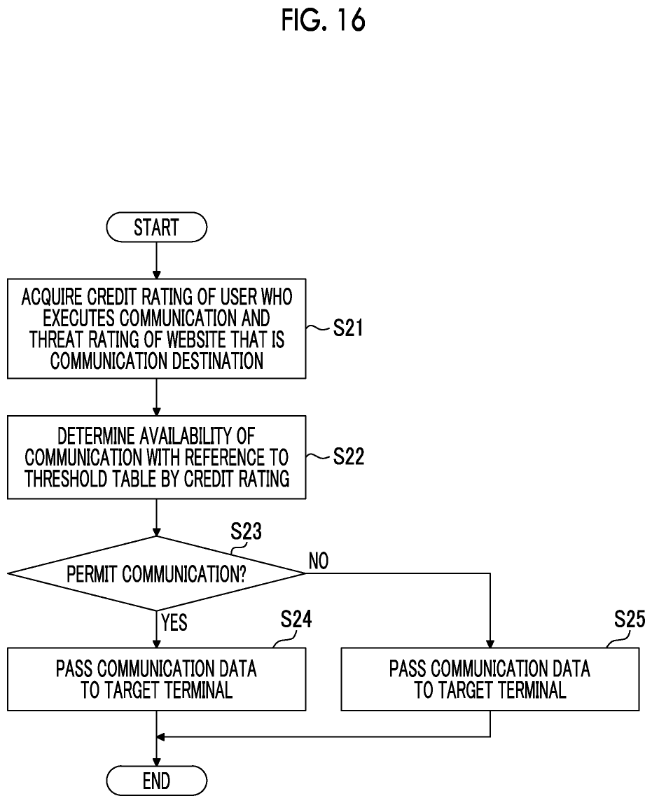

FIG. 16 is a flowchart illustrating an example of controlling communication by the blocking policy device 34.

The processing operation illustrated in FIG. 16 is achieved by executing a program by the control unit 341 (see FIG. 9).

The processing operation illustrated in FIG. 16 is executed for each communication between the terminal 32 (see FIG. 1) and the external web server 20.

The control unit 341 acquires the credit rating of the user who executes the communication and the threat rating of the website that is the communication destination (step S21). The control unit 341 specifies the user who executes the communication by using the IP address or the like of the terminal 32 which is the destination of the communication data. Further, the control unit 341 acquires the credit rating of the user from the credit rating DB 38 (see FIG. 10). Further, the control unit 341 acquires the threat rating of the website by using the domain of the website which is the transmission source of the communication data.

Next, the control unit 341 determines availability of communication, with reference to the threshold table 39 by credit rating (see FIG. 10) (step S22). In the case of the present exemplary embodiment, the availability of communication is determined according to the credit rating of the user and the threat rating of the website that is the communication destination.

Subsequently, the control unit 341 determines whether or not to permit communication (step S23).

In a case where a positive result is obtained in step S23, the control unit 341 passes the communication data to the target terminal 32 (see FIG. 10) (step S24).

On the other hand, in a case where a negative result is obtained in step S23, the control unit 341 blocks communication data from transmitting to the target terminal (step S25).

That is, in the present exemplary embodiment, the communication is controlled according to the combination of the credit rating of the user and the threat rating of the website that is the communication destination. Therefore, even in a case where a user with high security awareness, engaged in security-related work, wants to access a website with a high threat rating due to business necessity, the user can access the corresponding website. In other words, within the range of credit rating, users engaged in security-related work are more freely to access websites than users with low credit rating. This reduces business problems.

On the other hand, users with low credit rating are allowed to access the website only within the credit rating. Therefore, the risk of malware invading the LAN system 30 through users with low credit rating is reduced.

### Exemplary Embodiment 2

In the present exemplary embodiment, another method of updating the credit rating of a user for which a long time has passed since the previous training will be described.

Even in the case of Exemplary Embodiment 1 described above, the credit rating of the user is calculated using the degree most recent to the training date as the weighting in step S13 (see FIG. 15). Therefore, the longer the elapsed time, the smaller the weight on the training result. That is, the results of relatively new training are more likely to be reflected in the credit rating.

On the other hand, in a case where the elapsed time from the last training day becomes long, there is a high possibility that the calculated credit rating does not accurately reflect the user's current credit rating only by adjustment using weight.

Even so, in a case where there is no change in the credit rating of the user at the current time, there is no problem in controlling the communication even in a case where the credit rating calculated last time is used as it is.

However, in a case where security awareness is lowered, in a case where the credit rating calculated last time is used as it is, the current user is allowed to access a website with a high threat rating.

Therefore, in the present exemplary embodiment, a case where the credit rating is updated according to the elapsed time from the security training in which the user participates will be described.

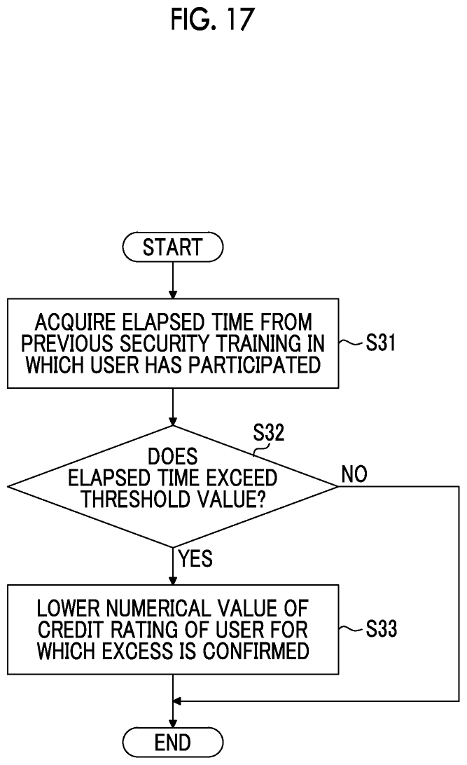

FIG. 17 is a flowchart illustrating a method of updating the credit rating used in Exemplary Embodiment 2.

The processing operation illustrated in FIG. 17 is achieved by the control unit 331 (see FIG. 2) executing the program.

The control unit 331 acquires the elapsed time from the previous security training in which the user has participated, at the timing when a new communication is detected (step S31).

Next, the control unit 331 determines whether or not the elapsed time exceeds the threshold value (step S32). The threshold is designated by the person in charge of security training or the administrator. For example, the threshold is set to three months or six months. However, the threshold value may be one month.

In a case where a negative result is obtained in step S32, there is no problem in using the credit rating. Therefore, the control unit 331 ends the process as it is.

On the other hand, in a case where a positive result is obtained in step S32, the control unit 331 lowers the numerical value of the credit rating of the user for which excess is confirmed (step S33). By decreasing the numerical value of the credit rating, current users are more likely to be blocked from accessing websites where accidents may occur. In other words, the security policy is changed to improve the security of communication.

The extent of decrease of the numerical value may be a fixed value or may be changed according to the elapsed time. For example, the longer the elapsed time, the greater the extent of the decrease.

Incidentally, since the purpose is to block access to websites that have a problem in relation to the true credit rating of the user, for example, it is desirable that the range of decrease is larger than the step width of the threshold table 39 by credit rating (see FIG. 10).

The processing operation described in the present exemplary embodiment is basically executed independently of the credit rating calculation process described in Exemplary Embodiment 1, but may be used in the correction of the credit rating calculated in step S13 (see FIG. 15).

Further, in the present exemplary embodiment, in step S31, the elapsed time from the security training in which the user has participated is acquired, but the elapsed time from the last communication may be acquired for the user who has not communicated for a long time due to a temporary leave, vacation, or the like. Further, the elapsed time from the last security test may be acquired, instead of the training email.

Further, instead of acquiring only one of these three types of elapsed time, all three types of elapsed time may be acquired, and in a case where any one of the elapsed times exceeds the threshold value, the numerical value of the credit rating may be lowered.

In the present exemplary embodiment, the numerical value of the credit rating is lowered, but the section to which the user's current credit rating belongs may be switched to a lower section, according to the threshold table 39 by credit rating (see FIG. 10).

### Exemplary Embodiment 3

In the present exemplary embodiment, a case where access to websites having different threat ratings is controlled by using the credit rating set for a unit in which a predetermined relationship is recognized with the user who executes the communication will be described.

Some business operators may want to manage access to websites having different threat ratings, on a basis different from the user.

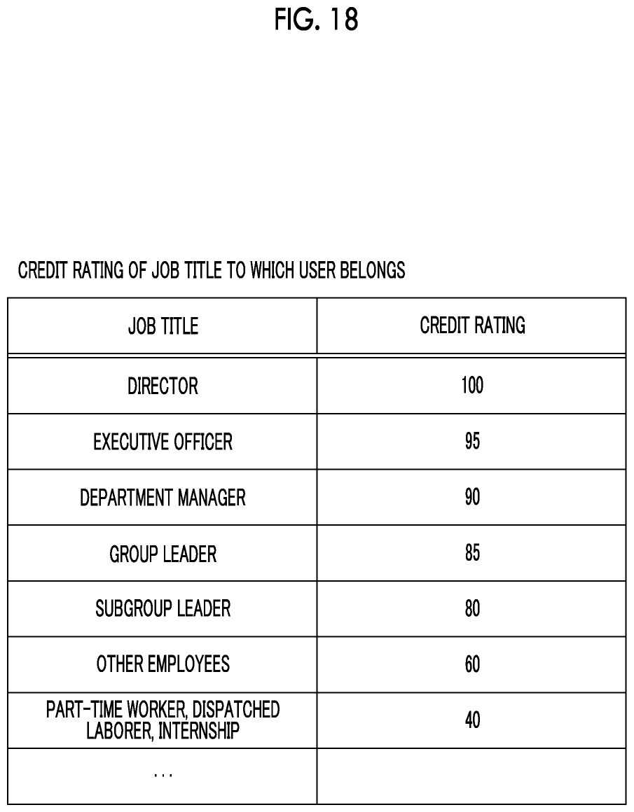

FIG. 18 is a diagram illustrating an example of managing credit rating used for controlling communication on a job title basis.

In FIG. 18, directors, executive officers, department managers, group leaders, subgroup leaders, other employees, “part-time workers, dispatched laborers, internships” and the like are illustrated as examples of job titles.

In the case of FIG. 18, the higher the job title, the higher the credit rating is mechanically assigned. In this setting example, the higher the job title, the higher the degree of freedom of access.

However, the average value of the credit ratings of the corresponding users may be calculated on a job title or occupation basis, and the calculated average value may be used as the representative value of the job title or occupation.

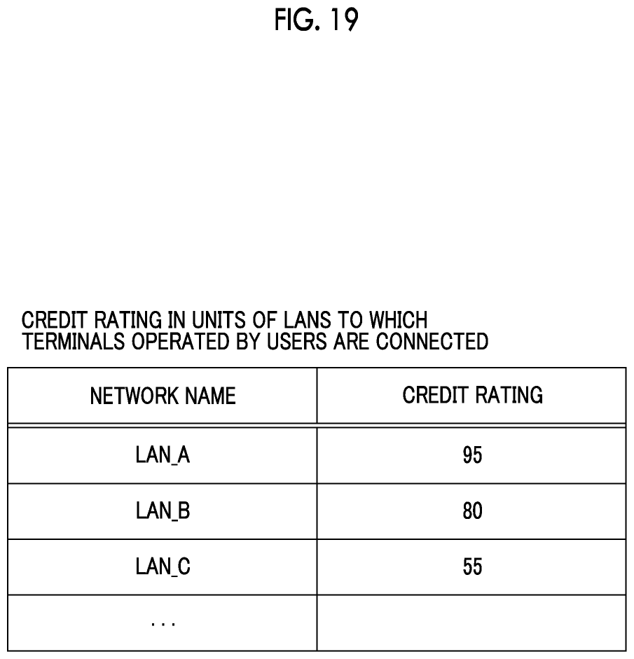

FIG. 19 is a diagram illustrating an example of managing credit rating used for controlling communication in units of LANs to which terminals 32 operated by users are connected.

In the case of FIG. 19, there are three networks to be managed, the credit rating of LAN_A is 95, the credit rating of LAN_B is 80, and the credit rating of LAN_C is 55.

Even in this case, the average value of the credit rating of the corresponding user may be calculated on a LAN basis, and the calculated average value may be used as the representative value of each LAN.

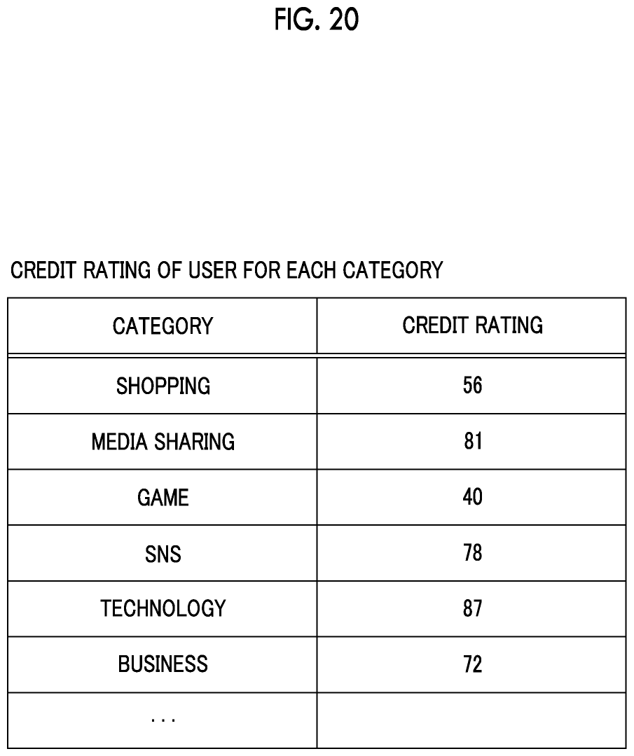

FIG. 20 is a diagram illustrating an example of managing the credit ratings of the users for each category.

In the case of FIG. 20, shopping, media sharing, games, SNS, technology, and business are illustrated as examples of categories, and individual credit rating is recorded for each category. The credit rating here is also calculated based on the results of security training and the like.

The user's security awareness may vary depending on category.

For example, in the case of FIG. 20, since security awareness is relatively high for media sharing, SNS, technology, and business, the credit ratings are also set as high numerical values. On the other hand, since security awareness is relatively low for shopping and games, the credit ratings are also set as low numerical values.

In a case where the credit rating is set on a category basis, as a function of the communication availability determination unit 3415 (see FIG. 10), for example, information indicating the category of the website that is the communication destination is acquired from the domain threat rating determination unit 3414 (see FIG. 10), and the availability of communication is controlled by using the credit rating corresponding to the acquired category.

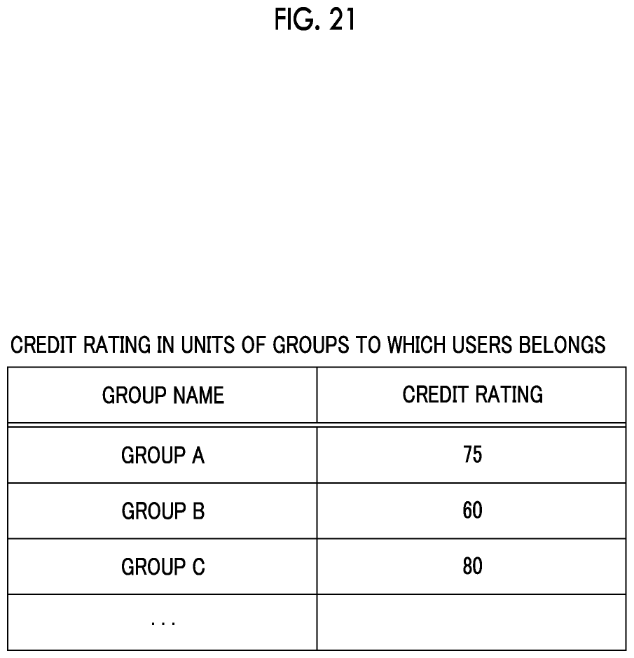

FIG. 21 is a diagram illustrating an example of managing the credit rating in units of groups to which users belongs.

In the case of FIG. 21, the group to which the user belongs is used as a unit, instead of the job title. The group here is assumed to be, for example, a department, a section, a team, or the like.

In the case of FIG. 21, the credit rating of group A is 75, the credit rating of group B is 60, and the credit rating of group C is 80.

In this case as well, the average value of the credit rating calculated for the users belonging to each group may be calculated, and the calculated average value may be used as the representative value of the group.

### Exemplary Embodiment 4

In the present exemplary embodiment, a case where a threshold table 39 (see FIG. 10) by credit rating is prepared for each category of the website that is the communication destination will be described.

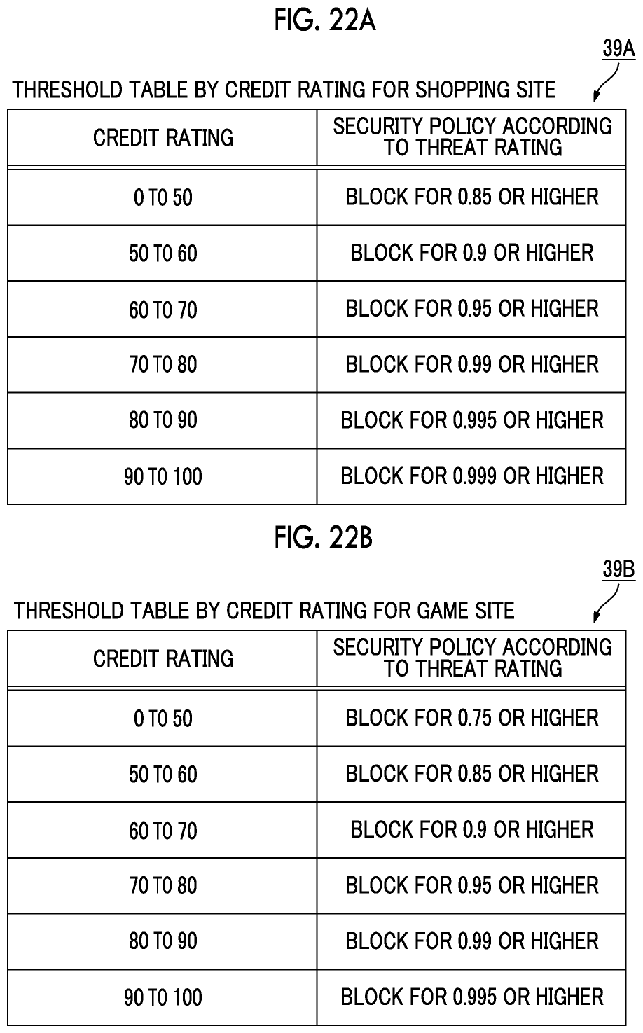

FIGS. 22A and 22B are diagrams illustrating an example of the threshold table 39 by credit rating prepared for each website category. FIG. 22A illustrates a threshold table 39A by credit rating for a shopping site, and FIG. 22B illustrates a threshold table 39B by credit rating for a game site.

In the case of FIGS. 22A and 22B, the units of delimiter of credit rating are the same, but the contents of the security policy according to the threat rating are different.

For example, in the threshold table 39A by credit rating for a shopping site, users having a credit rating of “0 to 50” are permitted to communicate with domains having a threat rating of less than 0.85, but are blocked from communicating with domains having a threat rating of 0.85 or higher.

On the other hand, in the threshold table 39B by credit rating for a game site, users having a credit rating of “0 to 50” are permitted to communicate with domains having a threat rating of less than 0.75, but are blocked from communicating with domains having a threat rating of 0.75 or higher.

That is, even in a case where the credit ratings of the users are the same, the result from the determination as to availability of communication differs depending on the category of the domain of the communication destination.

The delimiter of credit rating corresponding to the security policy according to the threat rating is common between the credit rating threshold table 39A and the credit rating threshold table 39B illustrated in FIGS. 22A and B, but the delimiter of credit rating may be changed on a table basis.

Further, although not illustrated in FIGS. 22A and 22B, a dedicated threshold table 39 by credit rating is prepared for each of the other categories.

### Exemplary Embodiment 5

In the present exemplary embodiment, a case where different threshold tables 39 by credit rating (see FIG. 10) are prepared according to the difference in the communication method of the request from the terminal 32 (see FIG. 1) for the domain of the communication destination will be described.

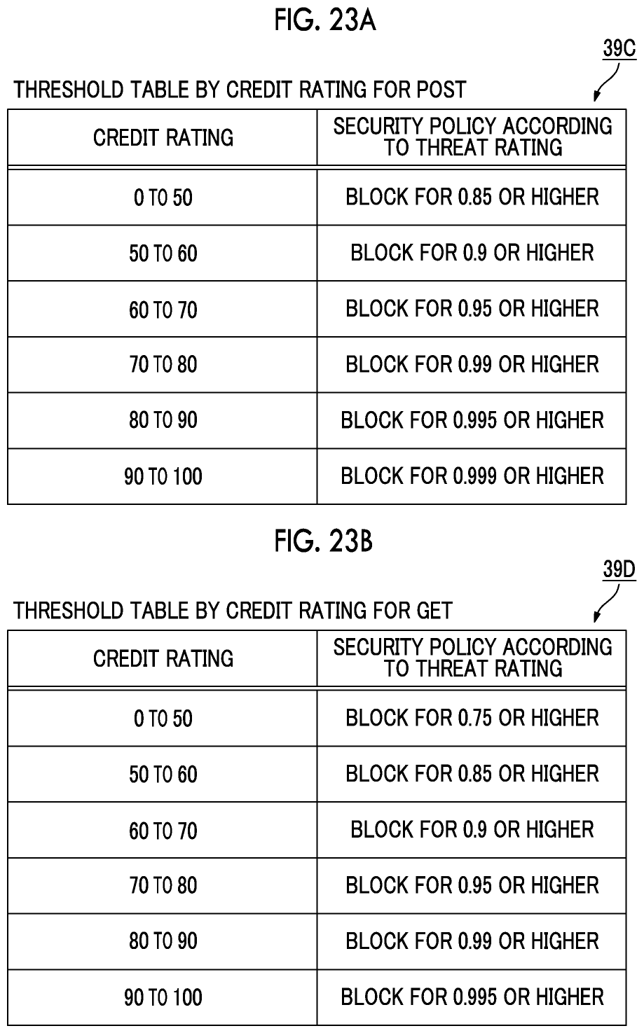

FIGS. 23A and 23B are diagrams illustrating an example of preparing different threshold tables 39 by credit rating according to a difference in a method of delivering input data. FIG. 23A illustrates a threshold table 39C by credit rating for POST, and FIG. 23B illustrates a threshold table 39D by credit rating for GET.

Here, POST is used, for example, to register data that does not include the input value in the URL, and GET is used, for example, to register data that includes the input value in the URL.

In the case of FIGS. 23A and 23B, the units of delimiter of credit rating are the same, but the contents of the security policy according to the threat rating are different.

For example, in the threshold table 39C by credit rating for POST, users having a credit rating of “0 to 50” are permitted to communicate with domains having a threat rating of less than 0.85, but are blocked from communicating with domains having a threat rating of 0.85 or higher.

On the other hand, in the threshold table 39D by credit rating for GET, users having a credit rating of “0 to 50” are permitted to communicate with domains having a threat rating of less than 0.75, but are blocked from communicating with domains having a threat rating of 0.75 or higher.

That is, even in a case where the credit ratings of the users are the same, the result from the determination as to availability of communication differs depending on the difference in the input data delivery method.

In the case of FIGS. 23A and 23B as well, the delimiter of credit rating corresponding to the security policy according to the threat rating is common between the two tables, but the delimiter of credit rating may be changed on a table basis.

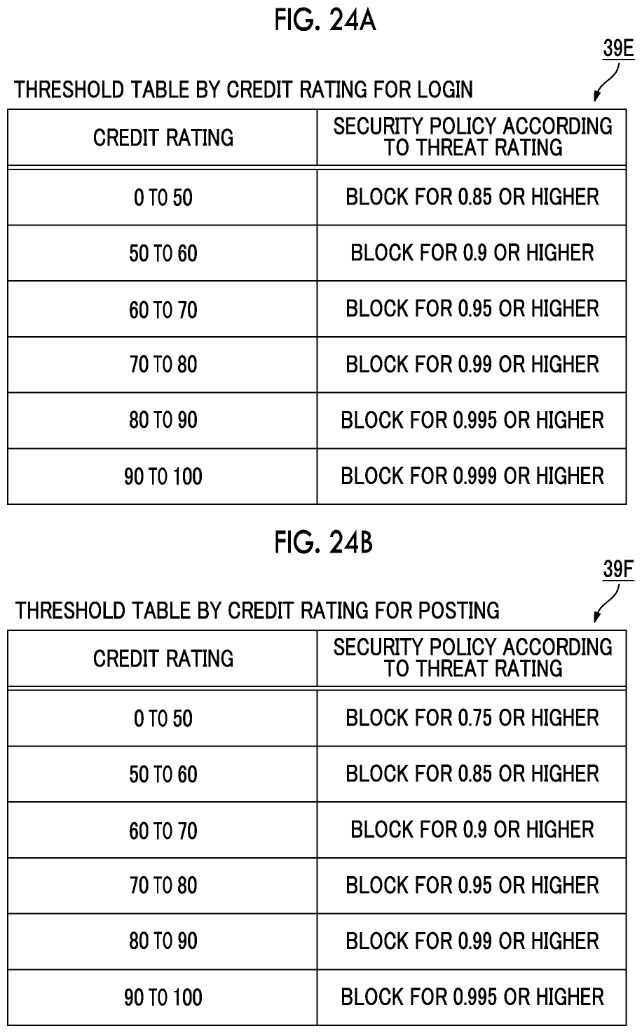

FIGS. 24A and 24B are diagrams illustrating an example of preparing different threshold tables 39 by credit rating according to a difference in action to a website of a communication destination. FIG. 24A illustrates a threshold table 39E by credit rating for login, and FIG. 24B illustrates a threshold table 39F by credit rating for posting.

In the case of FIGS. 24A and 24B, the units of delimiter of credit rating are the same, but the contents of the security policy according to the threat rating are different.

For example, in the threshold table 39E by credit rating for login, users having a credit rating of “0 to 50” are permitted to communicate with domains having a threat rating of less than 0.85, but are blocked from communicating with domains having a threat rating of 0.85 or higher.

On the other hand, in the threshold table 39F by credit rating for posting, users having a credit rating of “0 to 50” are permitted to communicate with domains having a threat rating of less than 0.75, but are blocked from communicating with domains having a threat rating of 0.75 or higher.

That is, even in a case where the credit ratings of the users are the same, the result from the determination as to availability of communication differs depending on the difference in the action.

In the case of FIGS. 24A and 24B as well, the delimiter of credit rating corresponding to the security policy according to the threat rating is common between the two tables, but the delimiter of credit rating may be changed on a table basis.

Further, in FIGS. 24A and 24B, login and posting are illustrated as examples of actions, but there are other actions such as uploading, authentication, and transmitting a message.

### Other Exemplary Embodiments

(1) Although the exemplary embodiments of the present invention have been described above, the technical scope of the present invention is not limited to the scope described in the above-described exemplary embodiments. It is clear from the description of the claims that the above-described exemplary embodiments with various modifications or improvements are also included in the technical scope of the present invention.

(2) In the case of the above-described exemplary embodiment, the credit rating calculation device 33 (see FIG. 1) that calculates the credit rating and the blocking policy device 34 that controls communication according to the security policy are separately provided, but both functions may be provided in a single device.

(3) In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute:
a function of acquiring a security credit rating of a user who operates a terminal used for communication;
a function of acquiring a security threat rating for a website that is a communication destination; and
a function of controlling the user's communication with the website, based on security policy according to a combination of the credit rating and the threat rating.

2. The non-transitory computer readable medium storing a program according to claim 1,
wherein as the security credit rating of the user, a credit rating in a predetermined administrative unit is used.

3. The non-transitory computer readable medium storing a program according to claim 2,
wherein in a case where the administrative unit is an individual, a credit rating set for the user is used.

4. The non-transitory computer readable medium storing a program according to claim 2,
wherein in a case where the administrative unit is a group, a credit rating set for a group to which the user belongs is used.

5. The non-transitory computer readable medium storing a program according to claim 2,
wherein in a case where the administrative unit is a job title, a credit rating set for a job title of the user is used.

6. The non-transitory computer readable medium storing a program according to claim 2,
wherein in a case where the administrative unit is a local area network (LAN), a credit rating set for a LAN to which the terminal operated by the user is connected is used.

7. The non-transitory computer readable medium storing a program according to claim 1,
wherein as the security credit rating of the user, a credit rating set for each classification to which the website of the communication destination belongs is used.

8. The non-transitory computer readable medium storing a program according to claim 2,
wherein as the security credit rating of the user, a credit rating set for each classification to which the website of the communication destination belongs is used.

9. The non-transitory computer readable medium storing a program according to claim 3,
wherein as the security credit rating of the user, a credit rating set for each classification to which the website of the communication destination belongs is used.

10. The non-transitory computer readable medium storing a program according to claim 4,
wherein as the security credit rating of the user, a credit rating set for each classification to which the website of the communication destination belongs is used.

11. The non-transitory computer readable medium storing a program according to claim 5,
wherein as the security credit rating of the user, a credit rating set for each classification to which the website of the communication destination belongs is used.

12. The non-transitory computer readable medium storing a program according to claim 6,
wherein as the security credit rating of the user, a credit rating set for each classification to which the website of the communication destination belongs is used.

13. The non-transitory computer readable medium storing a program according to claim 1,
wherein the security policy is prepared for each predetermined item.

14. The non-transitory computer readable medium storing a program according to claim 13,
wherein the item is a classification of the website.

15. The non-transitory computer readable medium storing a program according to claim 13,
wherein the item is a communication method used in a case of registering data on the website.

16. The non-transitory computer readable medium storing a program according to claim 13,
wherein the item is an action on the website.

17. The non-transitory computer readable medium storing a program according to claim 1,
wherein the credit rating is determined in consideration of any one or more elements of a result of a security training in which the user participates, history of past communication regarding the user, or a result of a security test conducted on the user in the past.

18. The non-transitory computer readable medium storing a program according to claim 17,
wherein in a case where the element is not updated within a predetermined period, the security policy used to control communication is changed in a direction of increasing security of the communication.

19. An information processing apparatus comprising:
a processor configured to:
acquire a security credit rating of a user who operates a terminal used for communication and a security threat rating for a website that is a communication destination; and
control the user's communication with the website, based on security policy according to a combination of the credit rating and the threat rating.

20. An information processing method comprising:
acquiring a security credit rating of a user who operates a terminal used for communication;
acquiring a security threat rating for a website that is a communication destination; and
controlling the user's communication with the website, based on security policy according to a combination of the credit rating and the threat rating.
